(19) United States
(12) Patent Application Publication
(10) Pub. No.: US 2009/0009424 A1
(43) Pub. Date: Jan. 8, 2009

(54) METHOD AND APPARATUS FOR DISPLAYING BROADCAST DATA USING PICTURE-IN-PICTURE

(75) Inventors: Seoung Ho KANG, Gumi-si (KR); Jae Wan PARK, Yongin-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/129,600

(22) Filed: May 29, 2008

(30) Foreign Application Priority Data
Jul. 4, 2007 (KR) 2007-0066972

(51) Int. Cl. H04N 5/45; G09G 5/00

(52) U.S. Cl. 345/1.3; 348/565; 348/E05.112

(57) ABSTRACT

A method and apparatus for displaying broadcast data using picture-in-picture are disclosed. According to an exemplary embodiment of the invention, the inset window (secondary screen), that is displaying a second broadcast, is prevented from overlapping with an object selected from the first broadcast, that is displayed on the primary screen, when the object moves to a location of the first screen that is overlapped by the second screen. The method includes selecting at least one object from the first broadcast displayed on the first screen and displaying, when the selected object moves to a location of the second screen that overlaps the first screen, the selected object at the location of the second screen.

### CLAIMS OF PRIORITY

This application claims the benefit under 35 U.S.C. §119(a) of a Korean patent application filed in the Korean Intellectual Property Office on Jul. 4, 2007 and assigned Serial No. 2007-0066972, the entire disclosure of which is hereby incorporated by reference.

### BACKGROUND OF THE INVENTION

1. Field of the Invention The present invention relates to a method and apparatus for displaying broadcast data using picture-in-picture. More particularly, the present invention relates to a method and apparatus for displaying broadcast data using picture-in-picture, wherein the inset window is displayed so as not to overlap with a selected object of the primary broadcast being displayed on the display screen.

2. Description of the Related Art

Development of Picture-In-Picture (hereinafter, referred to as “PIP”) technology has enabled a user to watch two broadcast programs on a single screen of a receiving device such as a television set or a portable terminal. In such a receiving device that includes the PIP technology, a portion of the screen displaying a first broadcast is referred to as a first screen, and a portion of the screen displaying a second broadcast is referred to as a second screen (e.g. an inset window).

However, in the existing PIP technology, if an object that is displayed as part of the first broadcast moves to a location of the first screen that is overlapped by the second screen, the user cannot properly view the object even though the object is a subject of interest to the user.

### SUMMARY OF THE INVENTION

An aspect of the present invention is to address the above-mentioned problems and/or disadvantages and to provide at least the advantages described below. Accordingly, an aspect of the present invention is to provide a method and apparatus for displaying broadcast data using picture-in-picture, wherein a second screen can be effectively displayed on the first broadcast.

Another aspect of the present invention is to provide a method and apparatus for displaying broadcast data using picture-in-picture, wherein a second screen overlapping an object of the first broadcast can be moved so that the object is readily viewed.

Still a further aspect of the present invention is to provide a method and apparatus for displaying broadcast data using picture-in-picture, wherein the transparency of a second screen overlapping an object of the first broadcast can be adjusted so that the object may be viewed.

Yet another aspect of the present invention is to provide a method and apparatus for displaying broadcast data using picture-in-picture, wherein an object of the first broadcast can be displayed on a second screen overlapping the first broadcast.

In accordance with an aspect of the present invention, a method for displaying broadcast data using a picture-in-picture feature that provides a first screen to display a first broadcast including at least one moving object and a second screen to display a second broadcast is provided. The method includes selecting at least one object from the first broadcast displayed on the first screen and displaying, when the object selected from the first broadcast moves to a location of the first screen overlapped by the second screen, the selected object at the location of the second screen.

In accordance with another aspect of the present invention, an apparatus for displaying broadcast data is provided. The apparatus includes a broadcast reception unit for receiving a plurality of broadcasts including a first broadcast with at least one object and a second broadcast a display unit for displaying the first broadcast on a first screen and for displaying the second broadcast on a second screen overlapping with the first screen and a control unit for controlling, when an object selected from the first broadcast moves to a location of the first screen overlapped by the second screen, an operation to display the selected object on the location of the second screen.

An exemplary feature of the present invention is that, when a selected object of a first broadcast displayed on the first screen overlaps with the second screen, the second screen is controlled so that the movement of the selected object can be easily viewed.

Another exemplary feature is that, even when an object of the first screen overlaps with the second screen, the object can still be viewed by moving the second screen or by displaying the object on the second screen.

Still a further exemplary feature is that the transparency of the second screen overlapped with an object of the first screen may be adjusted so that both the object of the first screen and a second broadcast of the second screen can be viewed and identified.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram illustrating a portable terminal according to an exemplary embodiment of the present invention;

FIGS. 2A and 2B are a flowchart illustrating a procedure to set broadcast data control options in a broadcast data display method according to an exemplary embodiment of the present invention;

FIG. 3 is a flowchart illustrating a procedure to display broadcast data using a broadcast data display method according to an exemplary embodiment of the present invention;

FIG. 4 is a flowchart illustrating a method for displaying broadcast data according to another exemplary embodiment of the present invention; and

FIGS. 5A to 5G illustrate screen representations for displaying broadcast data according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

In the description, an apparatus of an exemplary embodiment of the present invention is a PIP-enabled device that can receive and display video images or broadcasts, and may be any information and communication appliance or multimedia appliance, such as a portable terminal, mobile communication terminal, mobile phone, Personal Digital Assistant (PDA), smart phone, television set, personal computer, notebook computer and the like.

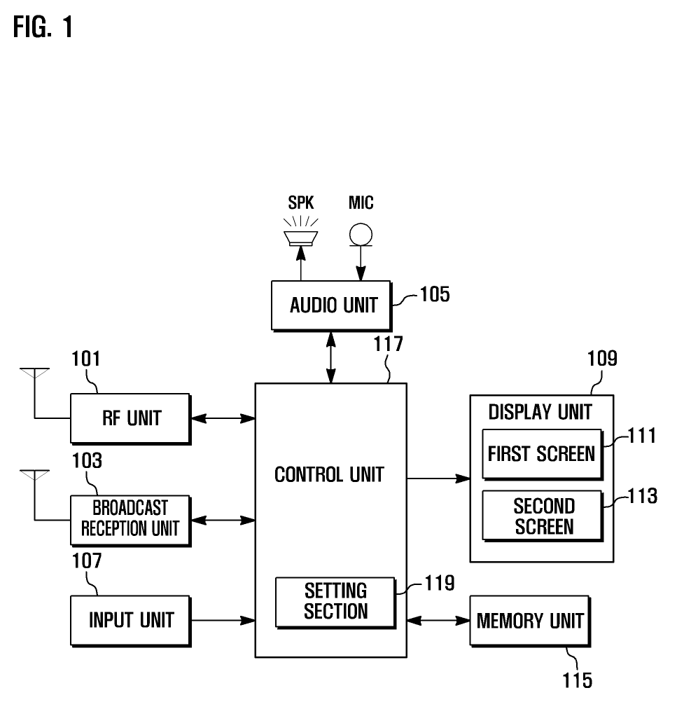

FIG. 1 is a block diagram illustrating a portable terminal according to an exemplary embodiment of the present invention.

Referring to FIG. 1, the portable terminal includes a radio frequency (RF) unit 101, a broadcast reception unit 103, an audio unit 105, an input unit 107, a display unit 109, a memory unit 115, a control unit 117, and a setting section 119. The display unit 109 includes a first screen 111 and a second screen 113.

The RF unit 101 performs normal wireless communications with a mobile communication network. For example, the RF unit 101 uses a mobile communication network to transmit and receive voice data, text messages, multimedia messages, and the like.

The broadcast reception unit 103 may include a tuner (not shown), for tuning to frequencies of a broadcast channel selected through the input unit 107, and a demodulator (not shown) for demodulating broadcast data from electromagnetic waves received through the tuner. The broadcast reception unit 103 receives plural broadcasts including a first broadcast and a second broadcast and sends them to the control unit 117.

The audio unit 105 converts an analog audio signal received from a microphone MIC into a digital audio signal and sends the digital audio signal to the control unit 117. Also, the audio unit 105 converts a digital audio signal received from the control unit 117 into an analog audio signal and outputs the analog audio signal through a speaker SPK.

The input unit 107 sends a selection signal for selecting at least one object of the first broadcast to the control unit 117. In an exemplary implementation, the input unit 107 includes a touch screen. Furthermore, the input unit 107 and the display unit 109 may together form a single touch screen. The input unit 107 may further include a key pad, a touch pad, and a scroll wheel.

The display unit 109 displays states and results of a series of operations performed in the internal blocks of the portable terminal, as well as various information regarding the state of the portable terminal, under the control of the control unit 117. The display unit 109 may include one or more display devices composed of a Liquid Crystal Display (LCD) device or an Organic Light Emitting Diode (OLED). Further, under the control of the control unit 117, the display unit 109 can display a first broadcast received through the broadcast reception unit 103 on the first screen 111, and also display a second broadcast on the second screen 113 such that the second screen is overlapped with the first screen 111.

The memory unit 115 stores information related to execution of programs for controlling the portable terminal, such as information on settings and menus, under the control of the control unit 117. The memory unit 115 also stores control options for the second screen 113 under the control of the control unit 117. Further, the memory unit 115 may store a program or the like for extracting a selected object from the first broadcast. Also, the memory unit 115 stores an object of the first broadcast selected according to a selection signal from the input unit 107, under the control of the control unit 117.

The control unit 117 controls the overall operation of the portable terminal. The control unit 117 may include a codec and a modem for coding/modulating a signal to be transmitted or received through the RF unit 101. In particular, the control unit 117 controls the broadcast reception unit 103 according to an input signal received from the input unit 107. Accordingly, the control unit 117 can select a broadcast channel corresponding to the applied input signal and receive broadcast data through the selected broadcast channel. The control unit 117 includes the setting section 119 to set control options for the second screen.

The setting section 119 sets control options of the second screen 113 to handle the case where an object selected from the first broadcast moves to the location of the second screen 113. The setting section 119 stores the setting results in the memory unit 115. As will be described in more detail below, control options for the second screen 113 may include movement of the second screen 113, adjustment of the transparency of the second screen 113, display of the selected object on the second screen 113 in an overlapping manner, removal of the second screen 113 and the like.

Further, the setting section 119 can set a location to which the second screen 113 moves as well as a transparency level of the second screen 113. To display a selected object on the second screen 113 in an overlapping manner, the setting section 119 can set an enlargement ratio for enlarging the object.

The control unit 117 stores an object selected through the input unit 107 in the memory unit 115. That is, the control unit 117 can store in the memory unit 115 an object selected according to a selection signal received from the input unit 107. Further, the control unit 117 can extract and display objects present in the first broadcast on the first screen 111 using an object extraction program stored in the memory unit 115. The control unit 117 can also store in the memory unit 115 one of displayed objects selected in response to a selection signal from the input unit 107. In addition, the control unit 117 tracks the movement of a selected object to determine whether the object moves to a location of the first screen that is overlapped by the second screen 113.

Further, when an object moves to the location of the first screen that is overlapped by the second screen 113, the control unit 117 controls the second screen 113 according to a control option set by the setting section 119. For example, the control unit 117 can move the second screen 113 to a location set by the setting section 119, adjust the transparency of the second screen 113 according to a transparency level set by the setting section 119, display the object in an overlapping manner on the second broadcast that is being displayed on the second screen 113, enlarge the object according to an enlargement ratio set by the setting section 119 and display the enlarged object through the display unit 109 and the like.

When the object moves out of the location of the first screen that is overlapped by the second screen 113, the control unit 117 restores the second screen 113 to a previous state in terms of location, transparency, displayed broadcast data and the like and continues to display first broadcast data in the first screen 111 and second broadcast data in the second screen 113.

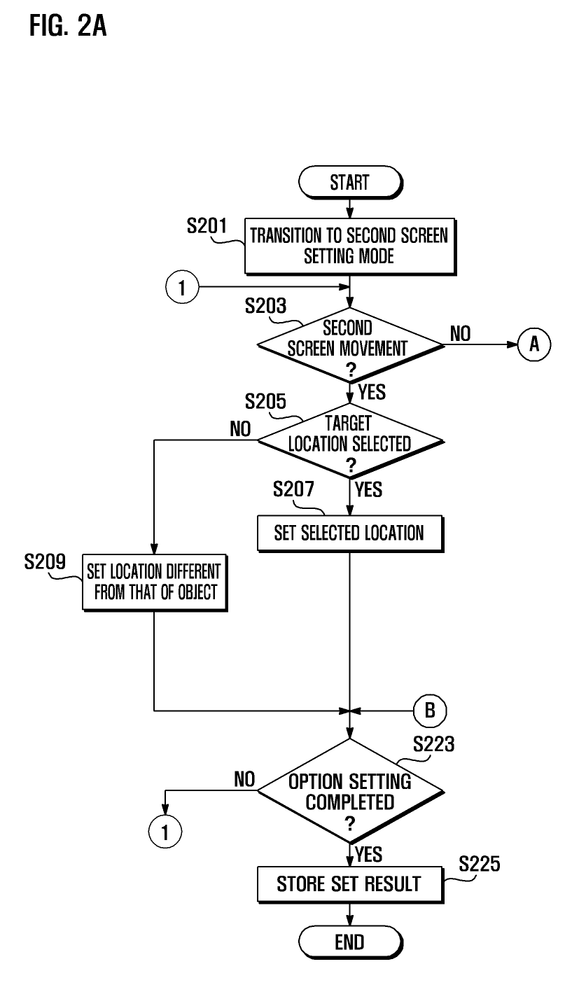

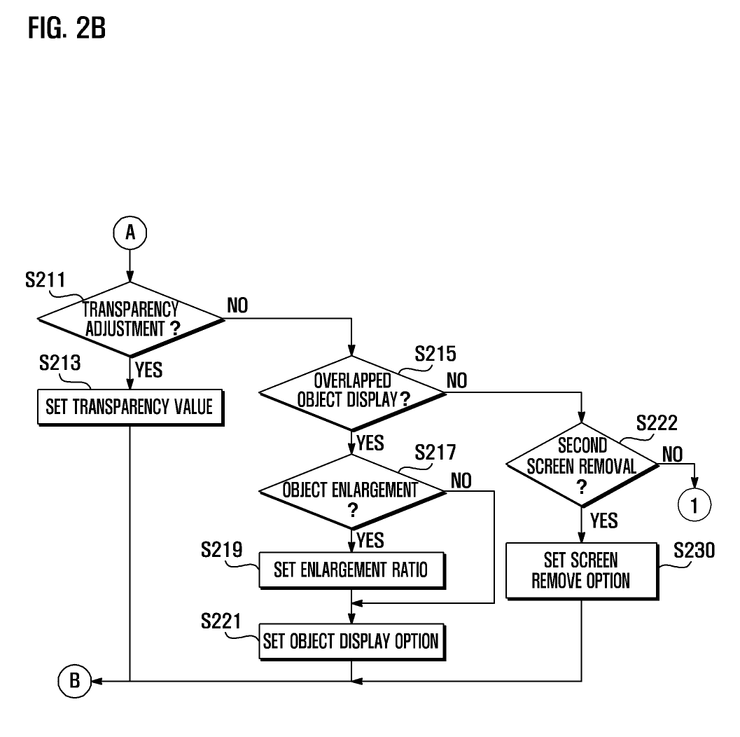

FIGS. 2A and 2B are a flowchart illustrating a procedure to set broadcast data control options according to an exemplary embodiment of the present invention.

Referring to FIG. 2, the control unit 117 transitions to a second screen setting mode in step S201 in order to set a control option for the second screen 113. The setting section 119 determines whether a screen move option is selected from the control options in step S203. As will be described in more detail below, the screen move option allows the user to select to move the second screen 113 when an object of the first screen 111 moves to a position that is overlapped by the second screen 113.

If a screen move option is selected in step S203, the setting section 119 determines in step S205 whether a target location to which the second screen 113 is to be moved is selected. In an exemplary implementation, the target location may be selected through the input unit 107. If a target location is selected, the setting section 119 sets the target location in step S207. If a target location is not selected, the setting section 119 can select and set the target location in step S209. As will be illustrated below, the target location set by the setting section 119 is a location different from that of an object to be selected from the first broadcast. As an example, the different location selected in either step S207 or step S209 may refer to the most distant location from the object to be selected. Of course, other locations may also be selected in either step.

If a screen move option is not selected in step S203, the setting section 119 determines whether a transparency adjust option is selected in step S211. As will be described in more detail below, a transparency adjust option allows for adjusting the transparency of the second screen 113. If a transparency adjust option is selected, the setting section 119 sets a transparency value for the second screen 113 to an input value in step S213.

If a transparency adjust option is not selected in step S211, the setting section 119 determines whether an object overlapping option is selected in step S215. The object overlapping options allows for display of the object on the second screen 113 in an overlapping manner. If an object overlap option is selected, the setting section 119 determines whether to enlarge the object in step S217. If object enlargement is determined, the setting section 119 sets an enlargement ratio for the object in step S219, and sets the object overlap option for overlapped display of a selected object on the second screen 113 in step S221. If object enlargement is not determined in step S217, the setting section proceeds directly to step S221 and sets the object overlap option for overlapped display of a selected object on the second screen 113.

If an object overlap option is not selected in step S215, the setting section 119 determines whether a screen removal option is selected in step S222. The screen removal option provides for removing of the second screen 113 from the first screen 111 so that the first screen 111 is displayed fully. If a screen removal option is selected, the setting section 119 sets the screen removal option for removing the second screen 113 from the first screen 111 in step S230.

Thereafter, the setting section 119 determines whether the control option setting for the second screen 113 is completed in step S223. If control option setting is completed, the setting section 119 stores the setting results in the memory unit 115 in step S225 and then ends the process. If control option setting is not completed, the setting section 119 returns to step S203 for changing of the setting result. Similarly, if a screen removal option is not selected in step S222, the setting section 119 returns to step S203 for changing of the setting result.

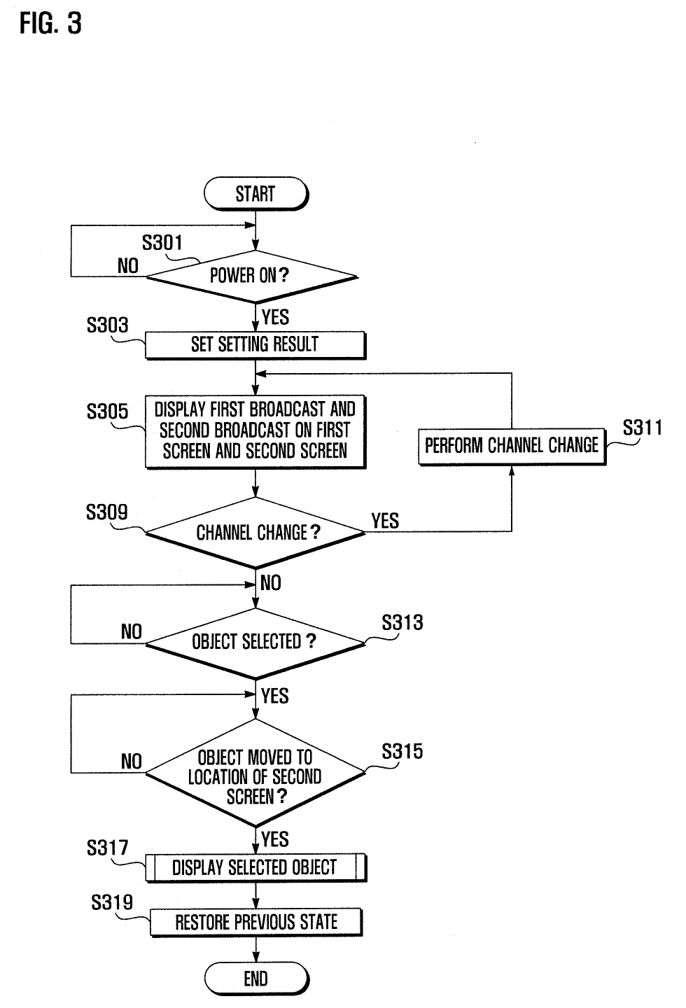

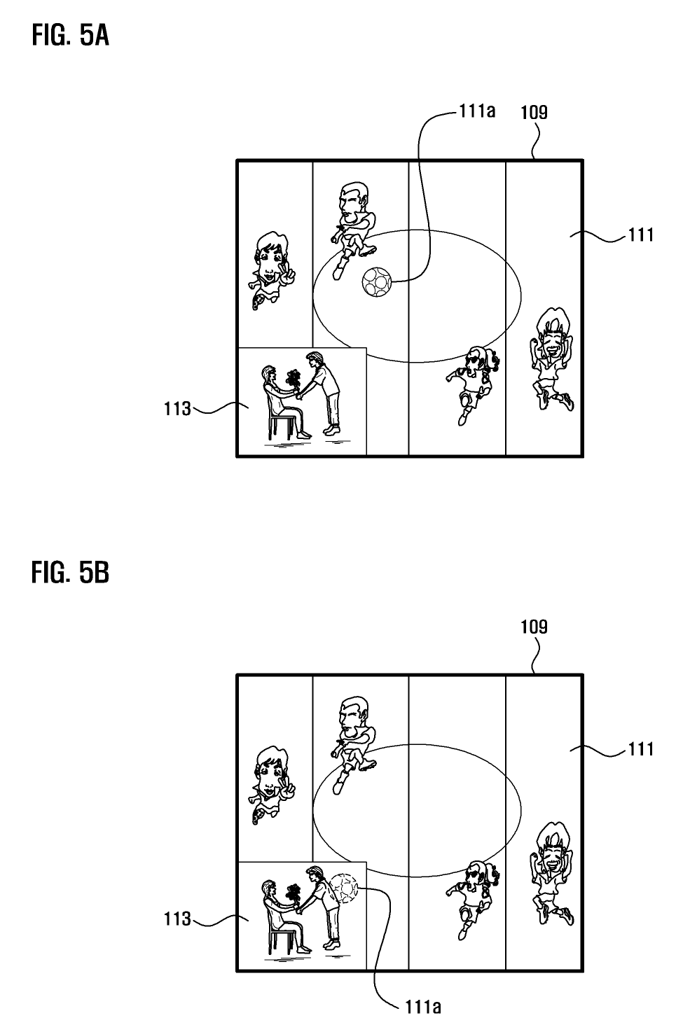

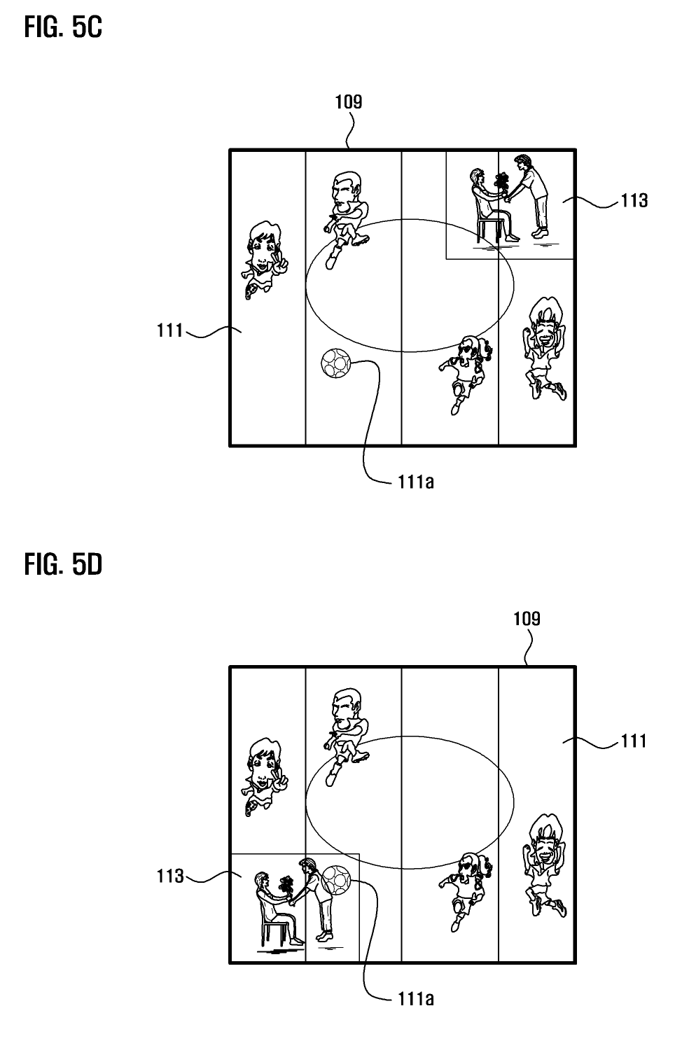

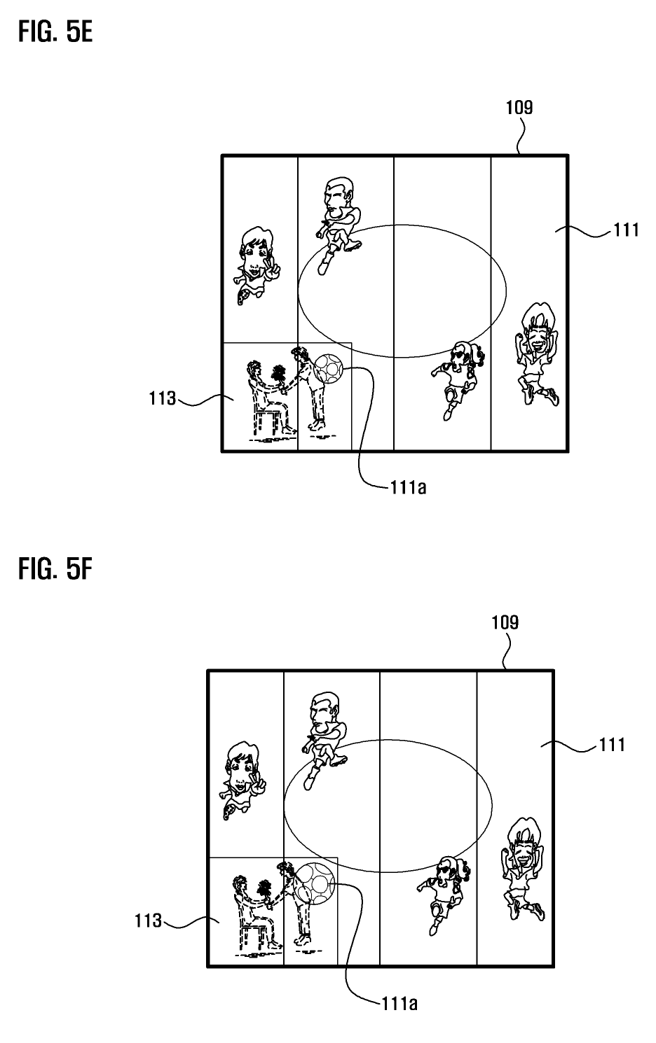

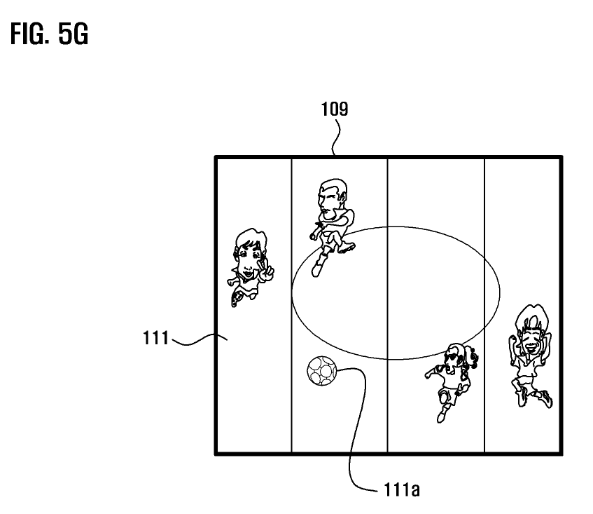

FIG. 3 is a flowchart illustrating a procedure for displaying broadcast data according to an exemplary embodiment of the present invention and FIGS. 5A to 5G illustrate examples of screen representations for displaying broadcast data.

Referring to FIG. 3, when the portable terminal is turned on in step S301, the control unit 117 sets control options specified through the procedure of FIGS. 2A and 2B in step S303.

In step S305, the control unit 117 displays a first broadcast received through the broadcast reception unit 103 on the first screen 111 and displays a second broadcast received through the broadcast reception unit 103 on the second screen 113 overlapped with the first screen 111. An example of such a PIP display is illustrated in FIG. 5A. During display of broadcast data, the control unit 117 determines whether a channel change request is received in step S309. If a channel change request is received, the control unit 117 changes the channel carrying broadcast data being displayed on the first screen or the second screen in step S311. Thereafter, the control unit 117 displays a first broadcast or a second broadcast corresponding to the new channel in step S305. Channel change can be applied to the first broadcast, the second broadcast or both.

When an object is selected from objects present in the first broadcast in step S313, the control unit 117 monitors whether the selected object 111a moves to the location of the first screen that is overlapped by the second screen 113 during display of broadcast data in step S315. Here, an object can be selected according to a selection signal generated by a touch on the input unit 107. The control unit 117 can extract objects present in the first broadcast using an object extraction program stored in the memory unit 115, and display the extracted objects on the first screen 111. The control unit 117 can also select one of the displayed objects according to a selection signal from the input unit 107.

Thereafter, when the selected object, for example object 111a of FIG. 5A, moves to a location of the first screen that is overlapped by the second screen 113 as shown in FIG. 5B, the control unit 117 displays the selected object 111a according to a selected option as shown in FIGS. 5C to 5G in step S317. It is noted for clarity that FIG. 5B illustrates the selected object 111a in outline merely to indicate its position on the first screen 111 relative to the second screen 113.

The various displays of the selected object 111a resulting from step S317 are described in more detail below with reference to FIGS. 5C to 5G. The control unit 117 displays the selected object in a manner corresponding to the setting result stored at step S225 and set at step S303.

For example, if the screen move option is set at step S303, the control unit 117 moves the second screen 113 to a target location as shown in FIG. 5C. The target location to which the second screen 113 is to be moved can be specified by the user (i.e. step S207 of FIG. 2A), and can be set to the most distant location from the object. Thus, the object is prevented from being overlapped by the second screen 113, and the user of the portable terminal can continuously view the movement of the object of interest.

If the transparency adjust option is set at step S303, the control unit 117 adjusts the transparency of the second screen 113 as shown in FIG. 5D. The transparency of the second screen 113 can be set by the user (i.e. step S213 in FIG. 2B). Thus, the transparency of the second screen 113 of the portable terminal is adjusted while the location of the second screen 113 is maintained as shown in FIG. 5D. Accordingly, the user of the portable terminal can identify the second broadcast and the selected object 111a at the same time.

If the object overlap option is set at step S303 and the enlargement ratio is not specified, the control unit 117 displays the selected object 111a on the second screen 113 in an overlapping manner as shown in FIG. 5E. In an exemplary implementation, the second broadcast (shown by the dotted lines in FIG. 5E) may be not displayed on the second screen 113.

If the object overlap option is set at step S303 and the enlargement ratio is specified, the control unit 117 enlarges the selected object 111a according to the enlargement ratio and displays the enlarged object 111a on the second screen 113 in an overlapping manner as shown in FIG. 5F. In an exemplary implementation, the second broadcast (dotted lines in FIG. 5F) may be not displayed on the second screen 113. Thus, the user of the portable terminal can readily identify the selected object 111a in an enlarged form without viewing the second broadcast.

If the screen removal option is set at step S303, the control unit 117 removes the second screen 113 from the first screen 111 as shown in FIG. 5G. Thereafter, the first broadcast is displayed on the first screen 111 of the display unit 109 in a full-screen mode.

Thereafter, the control unit 117 restores the second screen 113 to a previous state in step S319. That is, if the selected object 111a moves out of the location of the first screen that is overlapped by the second screen 113 (from the state depicted by FIGS. 5C to 5G), the control unit 117 restores the second screen 113 to a previous state in terms of location, transparency, and displayed broadcast data. In other words, the control unit 117 can move the second screen 113 to the previous location, adjust the transparency of the second screen 113 to the previous value, reduce the selected object to the previous size to display the reduced object on the first screen 111, or display the second screen 113 at the previous location on the first screen 111.

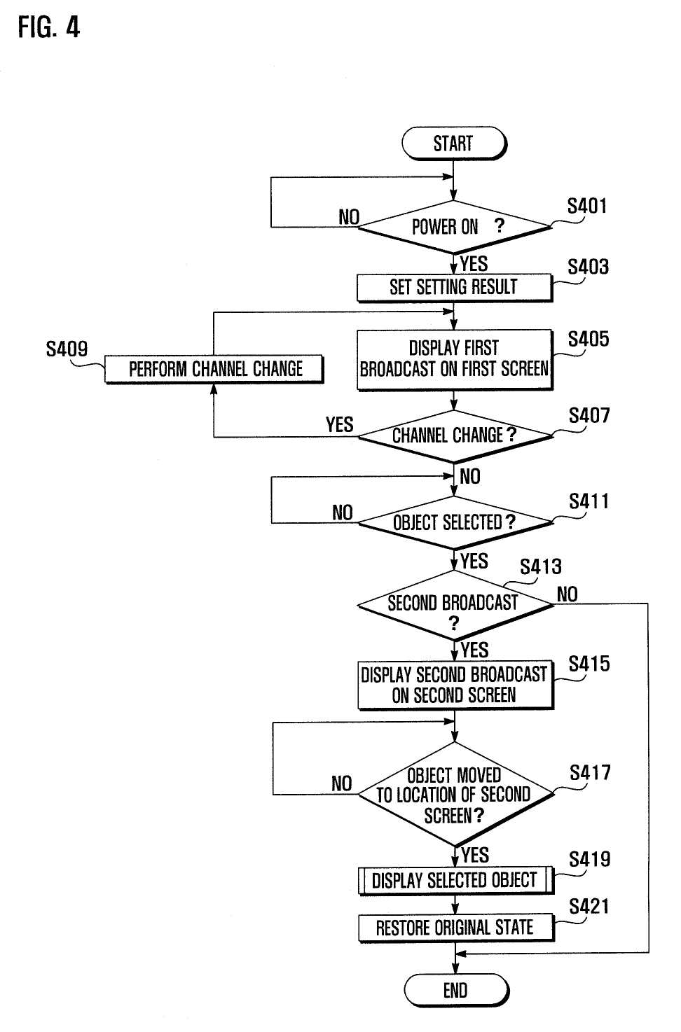

FIG. 4 is a flowchart illustrating a method for displaying broadcast data according to another exemplary embodiment of the present invention. In the flowchart of FIG. 4, an object is first selected from the first broadcast displayed on the first screen, and then the second broadcast is displayed on the second screen.

Referring to FIG. 1 to FIG. 5G, steps S401 and S403 of FIG. 4 are substantially identical to steps S301 and S303 of FIG. 3, respectively, and descriptions thereof are omitted for convenience.

The control unit 117 displays a first broadcast received through the broadcast reception unit 103 on the first screen 111 in step S405. Subsequent steps S407, S409 and S411 are substantially identical to steps S309, S311 and S313 of FIG. 3, respectively, and descriptions thereof are omitted for convenience.

The control unit 117 determines whether to display the second screen 113 on the display unit 109 in step S413. If the second screen 113 is determined to be displayed, the control unit 117 sends a selected channel for a second broadcast to the broadcast reception unit 103 and controls the broadcast reception unit 103 to display the received second broadcast on the second screen 113 overlapping with the first screen 111 in step S415.

Finally, steps S417, S419 and S421 are substantially identical to steps S315, S327 and S319 of FIG. 3, respectively, and descriptions thereof are omitted, again for convenience.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims and their equivalents.

What is claimed is:

1. A method for displaying broadcast data using a picture-in-picture feature that provides a first screen to display a first broadcast including at least one moving object and a second screen to display a second broadcast, the method comprising:
selecting at least one object from the first broadcast displayed on the first screen; and
displaying, when the object selected from the first broadcast moves to a location of the first screen that is overlapped by the second screen, the selected object at the location of the second screen.

2. The method of claim 1, wherein the selecting of the at least one object comprises:
displaying the first broadcast on the first screen;
selecting at least one object from the first broadcast; and
displaying the second screen on the first screen in an overlapping manner.

3. The method of claim 1, wherein the selecting of the at least one object comprises:
displaying the first broadcast on the first screen;
displaying the second broadcast on the second screen; and
selecting at least one object from the first broadcast.

4. The method of claim 1, wherein the displaying of the selected object comprises moving the second screen to a different location on the first screen and displaying the selected object on the first screen.

5. The method of claim 4, further comprising moving, when the selected object moves out of the location of the first screen that is overlapped by the second screen, the second screen to a previous location thereof.

6. The method of claim 1, wherein the displaying of the selected object comprises adjusting the transparency of the second screen.

7. The method of claim 6, further comprising restoring, when the selected object moves out of the location of the first screen that is overlapped by the second screen, the transparency of the second screen to a previous transparency.

8. The method of claim 1, wherein the displaying of the selected object comprises:
enlarging, when an enlargement ratio for the selected object is set, the selected object according to the enlargement ratio and displaying the enlarged object on the second screen in an overlapping manner; and
displaying, when an enlargement ratio is not set, the selected object on the second screen in an overlapping manner.

9. The method of claim 8, further comprising reducing, when the selected object moves out of the location of the first screen that is overlapped by the second screen, the object to a previous size and displaying the reduced object on the first screen.

10. The method of claim 1, wherein the displaying of the selected object comprises removing the second screen from the first screen to display the selected object.

11. The method of claim 10, further comprising restoring, when the selected object moves out of the location of the first screen that is overlapped by the second screen, the second screen at a previous location.

12. An apparatus for displaying broadcast data, comprising:
a broadcast reception unit for receiving a plurality of broadcasts including a first broadcast with at least one object and a second broadcast;
a display unit for displaying the first broadcast on a first screen, and for displaying the second broadcast on a second screen, wherein the second screen overlaps the first screen; and
a control unit for controlling, when an object selected from the first broadcast moves to a location of the first screen that is overlapped by the second screen, an operation to display the selected object at the location of the second screen.

13. The apparatus of claim 12, wherein the control unit controls selection of the object by displaying the first broadcast on the first screen, prompting a user to select the object from the first broadcast and displaying the second screen on the first screen in an overlapping manner.

14. The apparatus of claim 12, wherein the control unit controls selection of the object by displaying the first broadcast on the first screen, displaying the second broadcast on the second screen and selecting at least one object from the first broadcast.

15. The apparatus of claim 12, wherein the operation to display the selected object comprises moving the second screen to a different location on the first screen and displaying the selected object on the first screen.

16. The apparatus of claim 12, wherein the operation to display the selected object comprises adjusting the transparency of the second screen.

17. The apparatus of claim 12, wherein the operation to display the selected object comprises:
enlarging, when an enlargement ratio for the selected object is set, the selected object according to the enlargement ratio and displaying the enlarged object on the second screen in an overlapping manner; and
displaying, when an enlargement ratio is not set, the selected object on the second screen in an overlapping manner.

18. The apparatus of claim 12, wherein the operation to display the selected object comprises removing the second screen from the first screen to display the selected object.
